(19) United States
(12) Patent Application Publication
(10) Pub. No.: US 2025/0225263 A1
(43) Pub. Date: Jul. 10, 2025

(54) AI-VERS3-rolling data security methodology for continuous security control of artificial intelligence (AI) data

(71) Applicant: Betty Cumberland Andrea, Manassas Park, VA (US)

(72) Inventor: Betty Cumberland Andrea, Manassas Park, VA (US)

(21) Appl. No.: 18/445,730

(22) Filed: Jan. 4, 2024

(51) Int. Cl. G06F 21/62; G06F 21/57

(52) U.S. Cl. CPC G06F 21/6218; G06F 21/577; G06F 2221/034

(57) ABSTRACT

This present invention provides a process that provides a means for security controls setup on Artificial Intelligence data in the architecture of computer system and hardware environment through the continuous process of analyze, assess, implement and monitor data systems/applications, and hardware infrastructure. The computer system activates appropriate alerts for intrusion/access based on the process of monitoring continuously and alerting.

Additional interactive security control applications and the invention process can be incorporated into the software applications and systems by means of the computer system on the hardware infrastructure platform.

Use

The continuous process of Analyze, Assess, Implement and Monitor the Artificial Intelligence data security controls on the Enterprise Architecture Platform(s).

### CROSS REFERENCES TO RELATED APPLICATION

Not Applicable

### PREAMBLE OF THE INVENTION

The following specification particularly describes the invention in the manner in which it is to be performed and I claim in the following claim listings 1-3.

### (TECHNICAL) FIELD OF THE INVENTION

The present invention relates to the field of Artificial Intelligence (AI) data security specifically for AI data that is used by AI using a concept/process that continually Analyze, Assess, Implement and Monitor AI Data infrastructure. This is the best mode contemplated by the inventor of how to carry out the invention.

### BACKGROUND OF THE INVENTION

This invention relates in general to a system process and a method for management of AI data using concept process for continually Analyzing, Assessing, Implementing, and Monitoring AI data system infrastructure.

### SUMMARY DESCRIPTION

This invention of AI-Vers3 Rolling Data Security Methodology for continuous security control of Artificial Intelligence (AI) data. The present invention relates to the field of Artificial Intelligence (AI) data security specifically for AI data using a concept/process that continually Analyzes, Assess, Implements and Monitors AI Data Infrastructure. This is the best mode contemplated by the inventor of how to carry out the invention. The invention relates in general to a system and a method for management of AI data using concept process for continually Analyzing, Assess, Implement, Monitor data infrastructure as depicted in the Drawings FIG. 1 and FIG. 2, and outlined in the claims 1-3.

### OBJECTS OF THE INVENTION

The objective of this section is to bring about the necessity of the invention and In one embodiment of the invention a rolling data security process is in place as a necessity of the invention. In the another embodiment of the invention continuous monitoring and automatic update mechanism of data security controls and alert and update vulnerabilities.

### STATEMENT OF THE INVENTION

CLAIMS ARE INTENDED TO BE INTRODUCED ON SEPARATE PAGE AND ARE A CLAIM FOR COMBINATION AND POINTING OUT AND DISTINCTLY CLAIMING THE SUBJECT MATTER WHICH THE INVENTOR REGARDS AS THE INVENTION.

### BRIEF DESCRIPTION OF THE DRAWINGS

Various embodiments of the invention are disclosed in the following detailed description and accompanying drawings and process.

FIG. 1 illustrates top view embodiment of the design

FIG. 2 illustrates an expanded view of the design process to implement

### CONCLUSION

The specification shall conclude with one or more claims particularly point out and distinctly claiming the subject matter which the inventor regards as the invention.

### ELEMENT IN CLAIM FOR COMBINATION

An element in a claim for combination is express as a means for steps in a specified continuous flow function or acts in support thereof and such claim shall be construed to cover the process structure and the figures in the claim.

### DETAILED DESCRIPTION OF THE PREFERRED EMBODIMENTS OF THE INVENTION

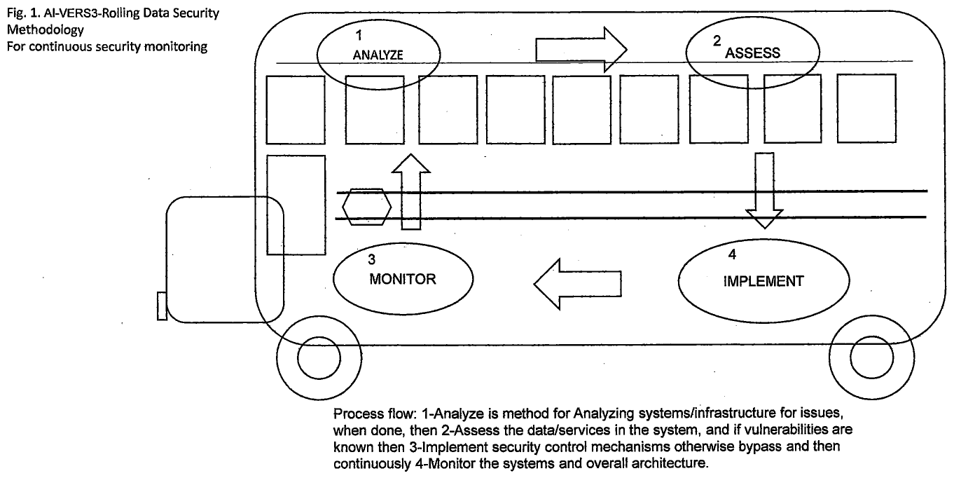

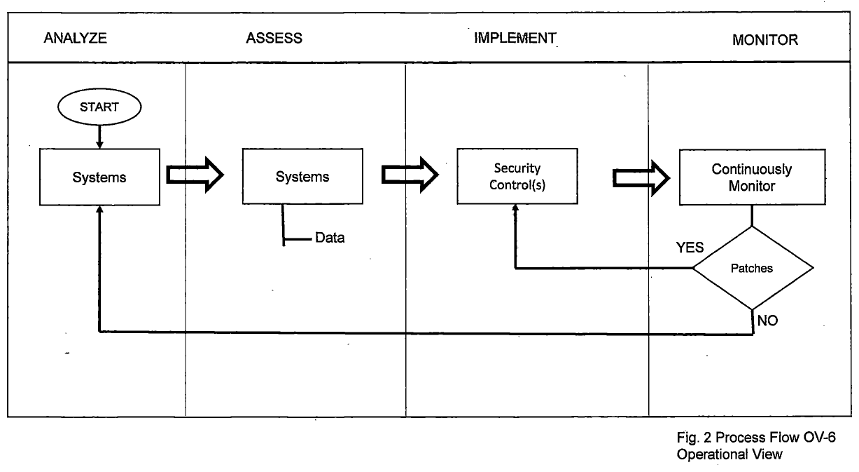

Please refer to FIG. 1 to FIG. 2. for the first embodiment of the present invention.

FIG. 1 illustrates top view embodiment of the design

FIG. 2 illustrates an expanded operational view of the design process to implement.

In reference to FIG. 1. the main body is the process flow using the continuous cycle of Analyze, Assess, Implement, Monitor the artificial intelligence (AI) data, that resides on a system that is on a hardware infrastructure architecture. To analyze the system for vulnerabilities, software applications are used to look for issues or access to the system data. Next is the process swimlane that assess the system data and its services, if found risk or issues in the assessment swimlane, then the Implementation will be to incorporate security controls for the data and its systems. The Monitor swimlane has control gate solution that monitors data, the systems, applications, and hardware infrastructure environment for breach in security controls.

In reference to FIG. 2. a DODAF (DoD Architecture Framework) methodology is used to depict the continuous process flow using a operational view (OV) 6. This configuration is the process event flow embodiment of the invention and distributed across the applications that house the AI data.

1: A computer system and hardware infrastructure architecture platform comprising;
A artificial intelligence (AI) data;
A appropriate security control(s);
A database for artificial intelligence (AI) data.

2: Objective of invention: Artificial Intelligence (AI) data will reside on the claim 1 where in a majority of the data will be embedded with appropriate security control mechanisms wherein the process performed in the FIG. 1. the process will continuously analyze, assess, implement, and monitor artificial intelligence (AI) data for breaches or issues.

3: Object of the Invention: A method to continually Monitor vulnerabilities using the AI-Vers3-Rolling Data Security process using continuous cycle of Analyze, Assess, Implement, Monitor the artificial intelligence (AI) data that resides on a system that is on a hardware/software infrastructure architecture platform. To analyze the system for vulnerabilities, software applications are used to look for issues or unauthorized access to system data and its services, and if found risk or issues in the assessment swim lane are identified, then the Implementation will be that user/system will be to incorporate appropriate security controls for the protection of data and its systems, applications, and hardware infrastructure environment for breach in security controls shown in FIG. 2.
